(19) United States
(12) Patent Application Publication
(10) Pub. No.: US 2021/0087936 A1
(43) Pub. Date: Mar. 25, 2021

(54) DETUNED TURBINE BLADE TIP SHROUDS

(71) Applicant: GE Avio S.r.l., Rivalta di Torino (IT)

(72) Inventor: Antonio Giuseppe D'Ettole, Rivoli (IT)

(21) Appl. No.: 17/025,536

(22) Filed: Sep. 18, 2020

(30) Foreign Application Priority Data
Sep. 25, 2019 (IT) 102019000017171

(51) Int. Cl. F01D 5/10; F01D 5/22

(52) U.S. Cl. CPC F01D 5/10; F05D 2260/96; F01D 5/225

(57) ABSTRACT

A shroud assembly for a rotary component of a gas turbine engine defining a central axis extending along an axial direction, a radial direction extending perpendicular to the axial direction, and a circumferential direction perpendicular to both the central axis and the radial direction. The shroud assembly includes a plurality of tip shrouds, and each of the plurality of tip shrouds includes a shroud band. Further, each tip shroud of the plurality of tip shrouds is coupled to one of the plurality of rotor blades at a tip end. The plurality of tip shrouds includes a first tip shroud defining a first length in a first direction and a second tip shroud defining a second length in the first direction. Moreover, the second length is different than the first length.

### PRIORITY INFORMATION

The present application claims priority to Italian Patent Application Number 102019000017171 filed on Sep. 25, 2019.

### FIELD

The present subject matter relates generally to tip shrouds of rotary components of turbomachines. More particularly, the present subject matter relates to a detuning of the tip shrouds of a rotary component.

### BACKGROUND

A gas turbine engine generally includes a fan and a core arranged in flow communication with one another. Additionally, the core of the gas turbine engine generally includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gases through the turbine section drives the turbine section and is then routed through the exhaust section, e.g., to atmosphere. Typically, the turbine section includes one or more stator vane and rotor blade stages, and each stator vane and rotor blade stage comprises a plurality of airfoils, e.g., nozzle airfoils in the stator vane portion and blade airfoils in the rotor blade portion.

In the field of gas turbines for aircraft engines, there has long been awareness of the need to increase performance by reducing weight as much as possible. In time, this has led to the construction of arrays of airfoils that, on the one hand are subjected to high aerodynamic loads and, on the other, have increasingly smaller thicknesses and therefore inevitably have low rigidity, both flexural and torsional. The reduced rigidity of the airfoils has, inevitably, resulted in the construction of turbines that have been found to be unstable under certain functional conditions. In particular, this instability is due to marked sensitivity to aeroelastic phenomena deriving from aerodynamic interactions between the airfoils of a same turbine stage, with the consequent triggering of vibrations that stress the arrays, leading them to structurally critical conditions, as well as generating noise emissions. This phenomenon of self-induced aeroelastic vibrations, known as flutter, thus defines a constraint in the design of arrays. Typically, airfoils can be made more rigid to minimize this phenomenon, with a consequent increase in their weight that, as explained above, is undesirable.

The susceptibility of the blades of a rotor disk to being excited by vibrations can be reduced by virtue of actively mistuning the rotor disk, so-called intentional mistuning; i.e., targeted deviations of the blade natural frequencies are added to the rotor blades in addition to the deviations of the blade natural frequencies that are down to the manufacturing process and/or material inhomogeneities and consequently random. The intentional mistuning of the system prevents, or reduces, vibratory energy at the resonance frequency of a blade being transported to other blades. A multiplicity of measures are known for realizing such intentional mistuning, said measures varying the blades of a rotor disk geometrically or in terms of their arrangement. By way of example, U.S. Pat. No. 6,428,278 B1 describes the mistuning of a rotor disk by way of material omissions at the blade tip or at the leading edge of the individual rotor blades.

As an advantageous example, it is known to vary, in the design of the array, the characteristics of a part of the airfoils so as to diverge from a standard configuration of axial symmetry. In other words, the geometry and/or the relative position of the airfoils in each array is/are determined so as to intentionally “detune” or “mistune” the eigenfrequencies of the critical vibrations modes between a first set of airfoils with respect to those of a second set. In this way, it is found that the aerodynamic interactions between airfoils of different types are reduced, thereby rendering the entire array more vibrationally stable. In known solutions with airfoils having intentionally detuned eigenfrequencies, aerodynamic efficiency usually drops. In fact, by varying the geometry on the high and low pressure sides and/or on the leading and trailing angles between airfoils of the first and second sets, the outflow conditions (pressure, gas flow directions, etc.) in the various inter-blade channels change radically with respect to that designed in a standard type of axial-symmetric situation.

U.S. Pat. No. 4,097,192 describes a turbine rotor that is intended to reduce flutter without impairing aerodynamic efficiency. In this case, the detuning is accomplished without altering the external geometry and the pitch between the airfoils, but by making a recess in a radial end of the airfoils of the first set and by making the airfoils of the second set with fully solid blades. In this rotor, the above-stated radial ends must be free and so they are not connected to each other by any outer annular platform. However, in some applications it is opportune, or even necessary, that the rotor has an outer annular platform interconnected with the airfoils, for which the solution of U.S. Pat. No. 4,097,192 cannot be effectively adopted. Furthermore, the machining for removing material and making the recesses at the radial end of a part of the airfoils takes extra production time and costs. Additionally, the airfoils without such removed materials would naturally include additional, undesirable weight that may reduce the efficiency of the gas turbine engine

Therefore, a rotary component with tip shrouds that are detuned would be welcome in the art.

### BRIEF DESCRIPTION

Aspects and advantages will be set forth in part in the following description, or may be obvious from the description, or may be learned through practice of the invention. In view of the above, the present invention provides a shroud assembly including compressible elements between shroud tips to form circumferential shroud.

In one aspect, the present disclosure is directed to a shroud assembly for a rotary component of a gas turbine engine defining a central axis extending along an axial direction, a radial direction extending perpendicular to the axial direction, and a circumferential direction perpendicular to both the central axis and the radial direction. The shroud assembly includes a plurality of tip shrouds, and each of the plurality of tip shrouds includes a shroud band. Further, each tip shroud of the plurality of tip shrouds is configured to be coupled to one of a plurality of rotor blades at a tip end. The plurality of tip shrouds includes a first tip shroud defining a first length in a first direction and a second tip shroud defining a second length in the first direction. Moreover, the second length is different than the first length.

In one embodiment, the first direction may be defined in the circumferential direction. In a further embodiment, the second length may be shorter than the first length. In another embodiment, the first tip shroud may include a first contact face in a first circumferential direction. Additionally, the first contact face may define a first contact angle relative to the axial direction. Further, the second tip shroud may define a second contact face in the first circumferential direction. The second contact face may define a second contact angle relative to the axial direction. Moreover, the second contact angle may be different than the first contact angle. In one such embodiment, the second contact angle is greater than the first contact angle.

In another embodiment, the plurality of tip shrouds may further include a first set of tip shrouds. Each tip shroud of the first set of tip shrouds may be configured as the first tip shroud. Additionally, the plurality of tip shrouds may further include a second set of tip shrouds. Moreover, each tip shroud of the second set of tip shrouds may be configured as the second tip shroud. In one such embodiment, each tip shroud of the first set of tip shrouds may alternate with each of the tip shrouds of the second set of tip shrouds in the circumferential direction.

In an additional embodiment, the plurality of tip shrouds may further include a third tip shroud defining a third length in the first direction. Further, the third length may be different than both the first length and the second length. In one such embodiment, the second length may be shorter than the first length and the third length is longer than the first length.

In another aspect, the present invention is directed to a rotary component for a gas turbine engine defining a central axis extending along an axial direction, a radial direction extending perpendicular to the axial direction, and a circumferential direction perpendicular to both the central axis and the radial direction. The rotary component includes a plurality of rotor blades. Further, each rotor blade of the plurality of rotor blades has a body extending radially from a root end coupled to a rotating shaft of the gas turbine engine to a tip end. Moreover, the plurality of rotor blades are arranged circumferentially in a stage. The rotary component further includes a plurality of tip shrouds. Each tip shroud of the plurality of tip shrouds includes a shroud band and is coupled to a rotor blade of the plurality of rotor blades at the tip end. The plurality of tip shrouds includes a first tip shroud defining a first length in a first direction. The plurality of tip shrouds further includes a second tip shroud defining a second length different than the first length in the first direction.

In one such embodiment, the plurality of tip shrouds may further include a first set of tip shrouds. Moreover, each tip shroud of the first set of tip shrouds may be configured as the first tip shroud. The plurality of tip shrouds may further include a second set of tip shrouds. Each tip shroud of the second set of tip shrouds may be configured as the second tip shroud. In one such embodiment, each tip shroud of the first set of tip shrouds may alternates with each of the tip shrouds of the second set of tip shrouds in the circumferential direction. In a further such embodiment, the plurality of rotor blades may further include a first set of rotor blades, and each rotor blade of the first set of rotor blades may be coupled to one of the first set of tip shrouds. The plurality of rotor blades may further include a second set of rotor blades, and each rotor blade of the second set of rotor blades may be coupled to one of the second set of tip shrouds. In such an embodiment, a combined weight of each rotor blade of the first set of rotor blades coupled to one of the first tip shrouds may weigh approximately the same as a combined weight of each rotor blade of the second set of rotor blades coupled to one of the second tip shrouds.

In another embodiment, the rotary component may define a circumferential gap between each of the plurality of rotor blades in the circumferential direction. Moreover, each circumferential gap may be is the same or approximately the same. In a further embodiment, the rotary component may be configured as a turbine of the gas turbine engine. In such an embodiment, each of the rotor blades may be configured as a turbine blade. It should be further understood that the rotary component may further include any of the additional features as described herein.

In a further aspect, the present disclosure is directed to a band assembly for a rotary component of a gas turbine engine defining a central axis extending along an axial direction, a radial direction extending perpendicular to the axial direction, and a circumferential direction perpendicular to both the central axis and the radial direction. The band assembly includes two or more bands configured as outer bands or inner bands. As such, each band is configured to be coupled to one of a plurality of airfoils at a tip end or a root end. Further, the bands include a first band defining a first length in a first direction. The bands also include a second band defining a second length in the first direction, the second length being different than the first length.

In one embodiment, each airfoil of the plurality of airfoils may be configured as a stator vane. In another embodiment, each band of the two or more bands may be configured as an outer band. In such an embodiment, each outer band may be configured to be coupled to one of the plurality of airfoils at the tip end. In another embodiment, each band of the two or more bands may be configured as an inner band. In such an embodiment, each inner band may be configured to be coupled to one of the plurality of airfoils at the root end. It should be further understood that the band assembly may further include any of the additional features as described herein.

These and other features, aspects and advantages will become better understood with reference to the following description and appended claims. The accompanying drawings, which are incorporated in and constitute a part of this specification, illustrate embodiments of the invention and, together with the description, serve to explain certain principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended FIGS., in which:

FIG. 1 illustrates a schematic cross-sectional view of a gas turbine engine in accordance with aspects of the present disclosure;

FIG. 2 illustrates a front view of a section of one embodiment of a rotary component for a gas turbine engine according to aspects of the present subject matter, particularly illustrates a stage of the rotary component configured as a shrouded rotary component;

FIG. 3 illustrates a pictorial view of one embodiment of a rotor blade according to aspects of the present disclosure, particularly illustrating a rotor blade that may be utilized within the rotary component of FIG. 2;

FIG. 4 illustrates one embodiment of portion a shroud assembly forming a portion of a circumferential shroud according to aspects of the present subject matter, particularly illustrating the shroud assembly including tip shrouds defining different circumferential lengths;

FIG. 5 illustrates a front view of a portion of an embodiment of the shroud assembly according to aspects of the present subject matter, particularly illustrating a shroud assembly including tip shrouds defining two distinct lengths; and

FIG. 6 illustrates a schematic top view of an alternative embodiment of a portion of the shroud assembly according to aspects of the present subject matter, particularly illustrating a shroud assembly defining different contact angles for the tip shrouds.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components, unless indicated otherwise.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The terms “communicate,” “communicating,” “communicative,” and the like refer to both direct communication as well as indirect communication such as through a memory system or another intermediary system.

A shroud assembly including tip shrouds defining different lengths, for example different lengths in the circumferential direction of the gas turbine engine, is generally disclosed. The shroud assembly generally includes tip shrouds including shroud bands coupled to tip ends of a stage of rotor blades of a rotary component. For example, the rotary component may be a shrouded turbine of the gas turbine engine. As such, the tip shrouds may together form a circumferential shroud. Further, tip shrouds defining different lengths may detune the stage of the rotary component. For instance, tip shrouds defining two different lengths may alternate around the perimeter of the stage of the rotary component. For example, tip shrouds defining different distinct lengths in combination with associated rotor blades may define distinct natural frequencies. As such, the use of tip shrouds having different natural frequencies may allow for detuning of the rotary component and thereby reduce stress on the components of the rotary component and the noise produced by the rotary component.

It should be appreciated that, although the present subject matter will generally be described herein with reference to a gas turbine engine, the disclosed systems and methods may generally be used on components within any suitable type of turbine engine, including aircraft-based turbine engines, land-based turbine engines, and/or steam turbine engines. Further, though the present subject matter is generally described in reference to rotor blades in a turbine section, the disclosed systems and methods may generally be used on any rotatable component where it may be desirable to fix the tips and/or end points together.

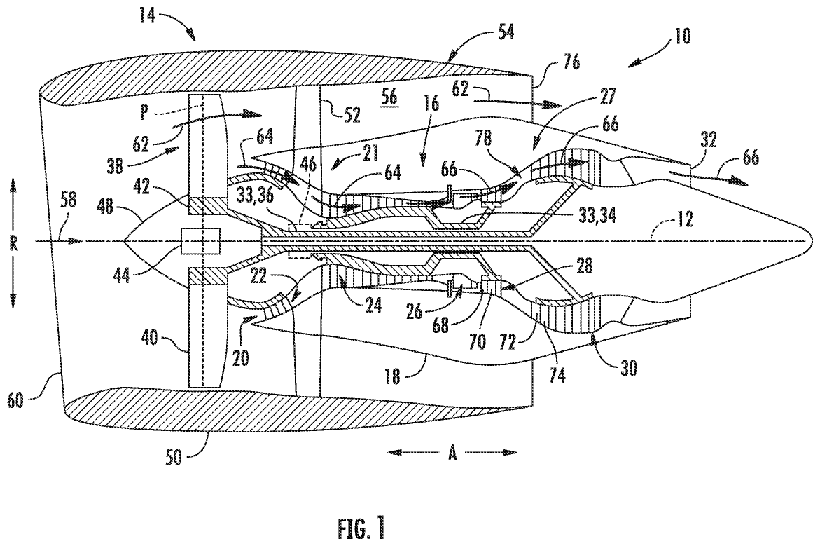

Referring now to the drawings, wherein identical numerals indicate the same elements throughout the figures, FIG. 1 is a schematic cross-sectional view of a gas turbine engine 10 in accordance with an exemplary embodiment of the present disclosure. More particularly, for the embodiment of FIG. 1, the gas turbine engine 10 is configured as a high-bypass turbofan jet engine. Though, in other embodiments, the gas turbine engine 10 may be configured as a low-bypass turbofan engine, a turbojet engine, a turboprop engine, a turboshaft engine, or other turbomachines known in the art. As shown in FIG. 1, the gas turbine engine 10 defines an axial direction A (extending parallel to a longitudinal centerline 12 provided for reference), a radial direction R perpendicular to the axial direction A, and a circumferential direction C perpendicular to the radial direction R. In general, the gas turbine engine 10 includes a fan section 14 and a core turbine engine 16 disposed downstream from the fan section 14.

The exemplary core turbine engine 16 depicted generally includes a substantially tubular outer casing 18 that defines an annular inlet 20. The outer casing 18 encases, in serial flow relationship, a compressor section 21 including a booster or low pressure (LP) compressor 22 and a high pressure (HP) compressor 24; a combustion section 26; a turbine section 27 including a high pressure (HP) turbine 28 and a low pressure (LP) turbine 30; and a jet exhaust nozzle section 32. The gas turbine engine 10 includes at least one rotating shaft 33 drivingly coupled between the compressor section 21 and the turbine section 27. For example, a high pressure (HP) shaft or spool 34 may drivingly connect the HP turbine 28 to the HP compressor 24. Similarly, a low pressure (LP) shaft or spool 36 may drivingly connect the LP turbine 30 to the LP compressor 22.

For the depicted embodiment, fan section 14 includes a variable pitch fan 38 having a plurality of fan blades 40 coupled to a disk 42 in a spaced apart manner. As depicted, fan blades 40 extend outward from the disk 42 generally along the radial direction R. Each fan blade 40 is rotatable relative to the disk 42 about a pitch axis P by virtue of the fan blades 40 being operatively coupled to a suitable actuation member 44 configured to vary the pitch of the fan blades 40. Fan blades 40, disk 42, and actuation member 44 are together rotatable about the longitudinal centerline 12 by the LP shaft 36 across a power gear box 46. The power gear box 46 includes a plurality of gears for stepping down the rotational speed of the LP shaft 36 to a more efficient rotational fan speed.

Referring still to the exemplary embodiment of FIG. 1, the disk 42 is covered by rotatable front nacelle 48 aerodynamically contoured to promote an airflow through the plurality of fan blades 40. Additionally, the exemplary fan section 14 includes an annular fan casing or outer nacelle 50 that circumferentially surrounds the variable pitch fan 38 and/or at least a portion of the core turbine engine 16. It should be appreciated that nacelle 50 may be configured to be supported relative to the core turbine engine 16 by a plurality of circumferentially-spaced outlet guide vanes 52. Moreover, a downstream section 54 of the nacelle 50 may extend over an outer portion of the core turbine engine 16 so as to define a bypass airflow passage 56 therebetween.

During operation of the gas turbine engine 10, a volume of air 58 enters the gas turbine engine 10 through an associated inlet 60 of the nacelle 50 and/or fan section 14. As the volume of air 58 passes across the fan blades 40, a first portion of the volume of air 58 as indicated by arrows 62 is directed or routed into the bypass airflow passage 56 and a second portion of the volume of air 58 as indicated by arrows 64 is directed or routed into the LP compressor 22. The ratio between the first portion of air 62 and the second portion of air 64 is commonly known as a bypass ratio. The pressure of the second portion of air 64 is then increased as it is routed through the high pressure (HP) compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft 34, thus causing the HP spool 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus causing the LP shaft 36 to rotate, thereby supporting operation of the LP compressor 22 and/or rotation of the fan 38.

The combustion gases 66 are subsequently routed through the jet exhaust nozzle section 32 of the core turbine engine 16 to provide propulsive thrust. Simultaneously, the pressure of the first portion of air 62 is substantially increased as the first portion of air 62 is routed through the bypass airflow passage 56 before it is exhausted from a fan nozzle exhaust section 76 of the gas turbine engine 10, also providing propulsive thrust. At least one of the combustion section 26, HP turbine 28, the LP turbine 30, or the jet exhaust nozzle section 32 at least partially define a flowpath 78 for routing the combustion gases 66 through the core turbine engine 16. Various components may be positioned in the flowpath 78 such as the HP turbine stator vanes 68, HP turbine rotor blades 70, the LP turbine stator vanes 72, and/or the LP turbine rotor blades 74.

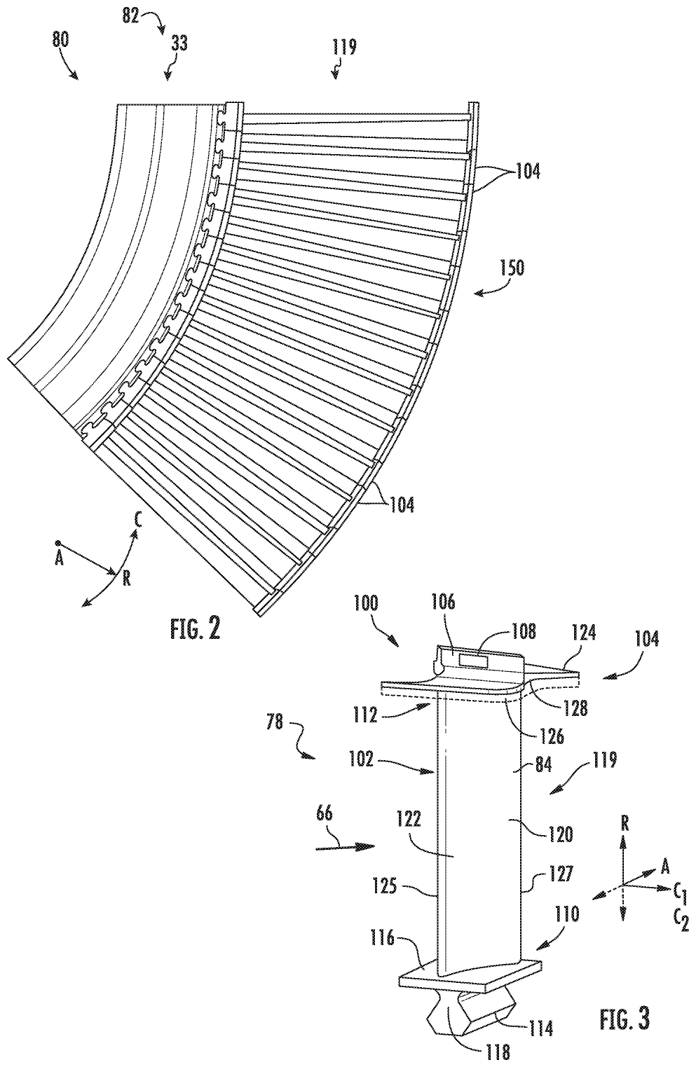

Referring now to FIG. 2, a front view of a section of one embodiment of a rotary component 80 for a gas turbine engine 10 is illustrated in accordance with aspects of the present subject matter. Particularly, FIG. 2 illustrates a stage 82 of the rotary component 80 configured as a shrouded rotary component. The rotary component 80 includes a plurality of rotor blades 119 coupled to a rotating shaft 33 of the gas turbine engine 10. As shown, the rotor blades 119 may be arranged circumferentially in the stage 82 of the gas turbine engine 10. Additionally, the rotary component 80 may include a plurality of tip shrouds 104 attached to tips of the rotor blades 119. In general, a shrouded rotary component may reduce leakage flow past the tips of the rotor blades 119 and thus direct the at least portion of the volume of air 58, such as combustion gases 66, between the rotor blades 119 of the gas turbine engine 10. Further, the tip shrouds 104 may help to ensure the same or approximately the same spacing between rotor blades 119 of the stage 82 of the rotary component 80. As such, a shrouded rotary component may increase the efficiency of the gas turbine engine 10 as well as provide stability to the stage 82 by coupling together to rotor blades 119 at their respective tips.

In the illustrated embodiment of FIG. 2, the rotary component 80 may be a turbine of the gas turbine engine 10 (e.g., the HP turbine 28 or the LP turbine 30). In such an embodiment, the rotor blades 119 may be configured as turbine blades (e.g., HP turbine rotor blades 70 or LP turbine rotor blades 74). As such, the rotating shaft 33 may be the HP shaft 34, the LP shaft 36, or any other suitable rotating shaft of the gas turbine engine 10. In further embodiments, it should be appreciated that the rotatory component 80 may be configured as any other shrouded rotary component of the gas turbine engine 10, such as one or more compressors (e.g., LP compressor 22 or HP compressor 24), fans (e.g., fan 38), or other turbines of the gas turbine engine 10.

Although the embodiment of FIG. 2 illustrates rotor blades 119 and the following description is described in reference to a rotor stage 82 of the rotary component 80, it should be understood that the present disclosure may be equally applicable to a stator stage of the rotary component 80. For instance, rather than rotor blades 119 and tip shrouds 104, the present subject matter may be applicable to stator vanes (e.g. HP turbine stator vanes 68, LP turbine stator vanes 72, the stator vanes of the LP compressor 22, and/or the stator vanes of the HP compressor 24) and the inner and/or outer bands of the stator vanes. Moreover, the inner and/or outer bands of the stator vanes may at least partially define the flowpath for the second portion of air 64 passing through the core turbine engine 16. The inner and/or outer bands may also ensure the same or approximately the same spacing between stator vanes of stator stage of the rotary component 80.

Referring now to FIG. 3, a pictorial view of one embodiment of the rotor blade 119 is illustrated according to aspects of the present disclosure. Further, it should be appreciated that the rotor blade 119 may be utilized within the rotary component 80 of FIG. 2 or any other suitable rotary component of the gas turbine engine 10. The turbine blade 119 may include a body 84 defining an airfoil 102. Further, the tip shroud 104 may be coupled, integrally coupled, or formed integrally with the rotor blade 119 at a tip end 112 of the rotor blade 119.

The body 84 defining the airfoil 102 may extend radially from a root end 110 coupled to the rotating shaft 33 (see FIG. 2) to the tip end 112. For example, the rotor blade 119 may include a dovetail 114 at the root end 110 for anchoring the body 84 to a disk by interlocking with a complementary dovetail slot formed in the circumference of the disk. As represented in FIG. 2, the interlocking features comprise protrusions referred to as tangs that engage recesses defined by the dovetail slot, though other interlocking features may be used. The turbine blade 119 is further shown as having a platform 116 that separates the airfoil 102 from a shank 118 on which the dovetail 114 is defined. It should be recognized that the dovetail 114 may be received by the disk attached to the HP shaft 34, the LP shaft 36, or any other rotating shaft 33 of the gas turbine engine 10. In certain embodiments, the airfoil 102, platform 116, and/or the dovetail 114 may define a rotor blade 119.

The airfoil 102 may further include a pressure side 120 and a suction side 122 extending between a leading edge 125 and a trailing edge 127. The airfoil 102 may extend into the flowpath 78 for the hot combustion gases 66. As such, the airfoil 102 may convert the kinetic and/or thermal energy of the hot combustion gases 66 into rotational energy to drive one or more components of the gas turbine engine 10, e.g., one or more compressors 22, 24 via the rotating shaft(s) 33.

The tip shroud 104 may include a shroud band 124 coupled to the tip end 112 of the body 84 of the rotor blade 119, such as the tip end 112 of the airfoil 102. In certain embodiments, the tip shroud 104 may define an outer most boundary of the flowpath 78 for the hot combustion gas 66. For instance, the shroud band 124 may define the outer most boundary of the flowpath 78. In other embodiments, the tip shroud 104 may further include an inner band 126 (shown in phantom) to define the inner most boundary of the flowpath 78. For instance, in certain embodiments of the tip shroud 104, the inner band 126 may include a thermal coating and/or an aerodynamically profiled band configured to promote the flow of the hot combustion gas 66 through the flowpath 78. The shroud band 124 may include one or more contact faces 128 oriented in a circumferential direction C. Further, such contact faces 128 may be operable with contact faces 128 of adjacent tip shrouds 104 in the circumferential direction C. In certain embodiments, the shroud band 124 may be a cast interface coupled to the rest of the tip shroud 104. It should be recognized that, the tip shroud 104, in combination with tip shrouds 104 of adjacent blades within the same stage 82, may define a circumferential shroud 150 (see, e.g., FIG. 2) around the rotor blades 119 that is capable of reducing airfoil vibrations and improving airflow characteristics.

A flange 106 may extend radially outward from the tip shroud 104. For example, the flange 106 may be coupled to the tip shroud 104, such as the shroud band 124. The flange 106 may generally reduce tip leakages between rotor blades 119 radially exterior to the tip shrouds 104. In certain embodiments, the flange 106 may be coupled to the body 84 and extend radially through the tip shroud 104 to extend radially outward from the shroud band 124. In other embodiments, the flange 106 may include part of the body 84 that extends through and past the shroud band 124 in the radial direction R. In other embodiments, the flange 106 may include a contact build-up on the shroud band 124. Still further, the flange 106 may be machined on to the shroud band 124. For example, the material surrounding the flange 106 may be removed, leaving the flange 106. In another embodiment, the one or more of the turbine blades 119 (such as all of the turbine blades 119 within a stage 82 of the rotary component 80) may include a plurality of flanges 106 extending from the tip shroud 104 and/or shroud band 124.

The rotary component 80 may further include a plurality of compressible elements 108 arranged between tip shrouds 104 (such as one compressible element 108 oriented toward one or both circumferential sides of the tip shroud 104) in order to dampen circumferential loads transferred between rotor blades 119 and/or to couple the rotor blades 119 together within the stage 82. For example, each of the plurality of compressible elements 108 may be oriented toward an adjacent tip shroud 104 such that the tip shrouds 104 mechanically engage to form the circumferential shroud 150. For example, a compressive force supplied by each of the compressible elements 108 may keep each of the plurality of tip shrouds 104 engaged with their respective adjacent tip shrouds 104 in a first circumferential direction C1. It should be recognized that friction between each first compressible element 108 and its respective adjacent tip shroud 104 may reduce displacements of the tip shrouds 104 and/or rotor blades 119 in the radial direction R and/or the axial direction A.

The compressible element(s) 108 may be coupled to at least one of the flange 106 or the tip shroud 104 and oriented in a first circumferential direction C1. It should be recognized that the first circumferential direction C1 may be the direction of rotation of the rotary component 80. For example, the first circumferential direction C1 may be the direction the rotating shaft 33 rotates. In other embodiments, the first circumferential direction C1 may be the opposite direction the rotary component 80 rotates. It should be recognized that the compressible element 108 may be coupled to the shroud band 124 directly. Further, the compressible element 108 may be coupled to two or more flanges 106 and/or the shroud bands 124. The compressible element 108 may be coupled to the flange 106 and/or tip shroud 104 using any suitable means, such as by adhesives, tape, braze, welding, and/or mechanical fasteners (e.g., bolts, screws, and rivets). For example, the compressible element 108 may be coupled to the flange 106 using a tack welded pin.

In one embodiment, at least two of the body 84, the tip shroud 104, or the flange 106 may be formed as a unibody. For example, the body 84 and the tip shroud 104 may be formed as single integral piece. In another embodiment, the unibody may include the tip shroud 104 and one or more flanges 106. In still further embodiments, all three of the body 84, the tip shroud 104, and the flange 106 may be formed as a single unibody. In other embodiments, the unibody may include other components such as the platform 116 and/or dovetail 114. As such, the unibody may include the rotor blade 119. In further embodiments, the unibody may include a ceramic matrix composite (CMC).

CMC materials generally comprise a ceramic fiber reinforcement material embedded in a ceramic matrix material. The reinforcement material may be discontinuous short fibers dispersed in the matrix material or continuous fibers or fiber bundles oriented within the matrix material. The reinforcement material serves as the load-bearing constituent of the CMC in the event of a matrix crack. In turn, the ceramic matrix protects the reinforcement material, maintains the orientation of its fibers, and serves to dissipate loads to the reinforcement material. Silicon-based composites, such as silicon carbide (SiC) as the matrix and/or reinforcement material, are of particular interest to high-temperature applications, for example, high-temperature components of gas turbines including aircraft gas turbine engines and land-based gas turbine engines used in the power-generating industry. However, other ceramic-based materials are also within the scope of the invention, nonlimiting examples of which include fibers and reinforcement materials formed of titanium carbide (TiC), silicon nitride (Si3N4), and/or alumina (Al2O3). Continuous fiber reinforced ceramic composites (CFCC) are a particular type of CMC that offers light weight, high strength, and high stiffness for a variety of high temperature load-bearing applications, including shrouds, combustor liners, vanes (nozzles), blades (buckets), and other high-temperature components of gas turbines. A notable example of a CFCC material developed by the General Electric Company under the name HiPerComp® contains continuous silicon carbide fibers in a matrix of silicon carbide and elemental silicon or a silicon alloy.

Examples of CMC materials and particularly SiC/Si-SiC (fiber/matrix) CFCC materials and processes are disclosed in U.S. Pat. Nos. 5,015,540; 5,330,854; 5,336,350; 5,628,938; 6,024,898; 6,258,737; 6,403,158; and 6,503,441; and U.S. Patent Application Publication No. 2004/0067316. One such process is known as “prepreg” melt-infiltration (MI), which in general terms entails the fabrication of CMCs using multiple prepreg layers, each in the form of a tape-like structure comprising the desired reinforcement material, a precursor of the CMC matrix material, and one or more binders.

A particular embodiment of the present invention may be the ability to produce the tip shroud 104 with prepreg layers that also form at least part of the airfoil 102, such that the tip shroud 104 is a fully integrated part of the airfoil 102. Further, the prepreg layers that form part of the airfoil 102 and/or the tip shroud 104 may also form part of the flange 106 as a fully integrated part of the airfoil 102. The unitary airfoil 102, tip shroud 104, and/or flange 106 can be fabricated from ceramic-based materials produced using known processes, for example, with the use of prepregs. As a particular example, the unitary airfoil 102, tip shroud 104, and flange 106 can be fabricated by the previously-described prepreg melt-infiltration (MI) process, wherein multiple prepregs are formed to contain one or more desired reinforcement materials and a precursor of the CMC matrix material, as well as one or more binders. The prepregs undergo lay-up, are debulked and cured while subjected to elevated pressures and temperatures, and may undergo various other processing steps to form a laminate preform. Thereafter, the laminate preform may be heated (fired) in a vacuum or an inert atmosphere to decompose the binders and produce a porous preform, which can then be melt infiltrated. If the CMC material comprises a silicon carbide reinforcement material in a ceramic matrix of silicon carbide (a SiC/SiC CMC material), molten silicon is typically used to infiltrate the porosity, react with a carbon constituent (carbon, carbon source, or carbon char) within the matrix to form silicon carbide, and fill the porosity. However, it will be apparent from the following discussion that the invention also applies to other types and combinations of CMC materials. Furthermore, it is foreseeable that the unibody airfoil 102, tip shroud 104, and/or flange 106 could be fabricated with the use of materials other than prepregs, for example, plies of reinforcement material that are infiltrated after being laid-up.

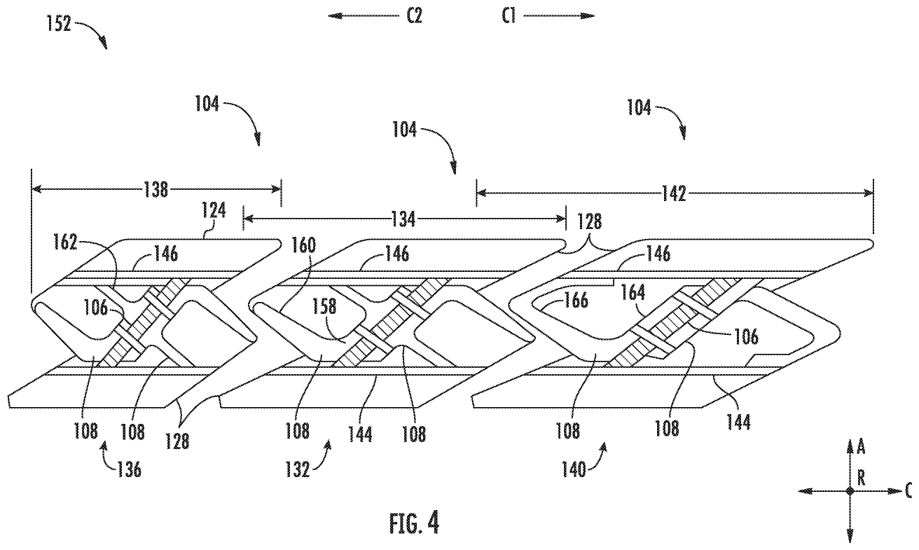

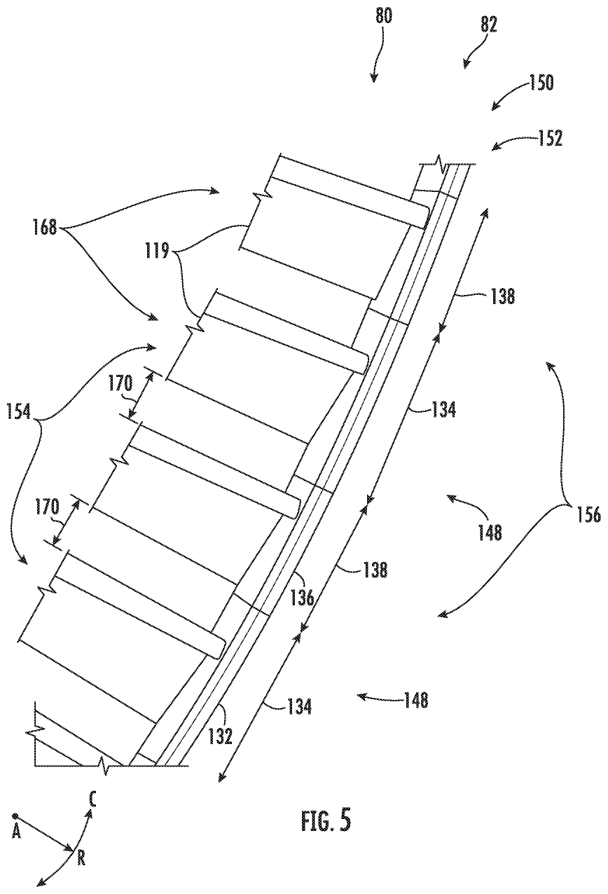

Referring now to FIG. 4, one embodiment of portion a shroud assembly 152 forming a portion of the circumferential shroud 150 is illustrated in accordance with aspects of the present subject matter. More particularly, FIG. 4 illustrates the shroud assembly 152 including tip shrouds 104 defining different circumferential lengths. Tip shrouds 104 defining different length may leave the fluid dynamic conditions of the gas flow through the rotary component 80 substantially unchanged while also detuning the eigenfrenquencies of the rotor blades 119 within the stage 82. For example, tip shrouds 104 of different lengths may allow for the detuning of the eigenfrequencies of the critical vibration modes while maintaining approximately the same combined weight between rotor blade 119 and tip shroud 104 combinations. Here, detuning is understood to, in view of at least one vibration mode, to specify a mistuning or a frequency deviation of the natural frequency from a nominal frequency for one or more rotor blade 119 of the stage 82 of the rotary component 80. Here, the nominal frequency is the natural frequency that the rotor blades 119 would have in the absence of any mistuning in the vibration mode considered. Consequently, aspects of the present subject matter relate to provision of a mistuning pattern of one or more stages 82 of the rotary component 80 that, in view of at least one vibration mode, specifies natural frequencies of the individual rotor blades 119 that differ from one another and, as a result thereof, provide the mistuning of the rotary component 80.

While the following description is in reference to the rotor blades 119 and tip shrouds 104 of the rotor stage 82 of the rotary component 80. It should be appreciated that the disclosure may be equally applicable to stator vanes and inner and/or outer bands coupled to a roots or tips of the stator vanes respectively. For instance, the vibrations of the rotating components 80 of the gas turbine engine 10 may cause the stator vanes to vibrate at their natural frequencies. Inner and/or outer bands associated with the stator vanes (e.g. HP turbine stator vanes 68, LP turbine stator vanes 72, the stator vanes of the LP compressor 22, and/or the stator vanes of the HP compressor 24) of the gas turbine engine 10 defining different lengths may leave the fluid dynamic conditions of the gas flow through the rotary component 80 substantially unchanged while also detuning the eigenfrenquencies of the stator vanes within the stator stage. For instance, as described below in reference to the tip shrouds 104, the inner bands and/or outer bands may define two or more different lengths in the circumferential direction C and may alternate in the circumferential direction C. Consequently, aspects of the present subject matter also relate to provision of a mistuning pattern of one or more stator stages of the rotary component 80 that, in view of at least one vibration mode, specifies natural frequencies of the individual stator vanes that differ from one another and, as a result thereof, provide the mistuning of the rotary component 80.

As shown in FIG. 4, the each of the tip shrouds 104 may include one or more seal teeth 144, 146. Each of the seal teeth 144, 146 may extend radially outward from one of the plurality of tip shrouds 104. For example, the seal teeth 144, 146 may extend radially outward from the shroud band 124. The seal teeth 144, 146 may be in sealing engagement with the outer casing 18 of the gas turbine engine 10 (see, e.g., FIG. 1). For example, the outer casing 18 may define one or more slots to receive the seal teeth 144, 146. The seal teeth 144, 146may prevent the hot combustion gases 66 from leaking past the tip shroud 104 and flowing axially down any gap or cavities between the tip shroud 104 and the outer casing 18.

In further embodiments, the shroud assembly 152 may include a plurality of additional sealing elements positioned between the tip shrouds 104 in the circumferential direction C. Such additional sealing elements may reduce the amount of hot combustion gases 66 that flow between the tip shrouds 104 instead of through the flowpath 78 defined radially between the tip shrouds 104 and the platform 116. It should be recognized that the sealing elements may accommodate a variable gap between the tip shrouds 104. For example, the gaps between tip shrouds 104 may be at a maximum value when the gas turbine engine 10 is operating at a maximum RPM. Similarly, the gaps between tip shrouds 104 may be a minimum value when the gas turbine engine 10 is operating at a minimum RPM.

In embodiments where the tip shroud(s) 104 include at least one of the seal teeth 144, 146, the at least one of the seal teeth 144, 146 may be formed as a unibody with at least one other components of the rotary component 80. For example, in certain embodiments, at least two of the body 84, the tip shroud 104, the flange 106, or the seal teeth 144, 146 may be formed as the unibody, such as a unibody including a ceramic matrix composite.

Additionally, FIG. 4 illustrates the shroud assembly 152 with spring compressible elements 108. For example, at least one of the compressible elements 108 may include a spring. For instance, the spring may include a first segment 158 coupled to the flange 106 and/or the tip shroud 104 and a second segment 160 extending from the first segment 158 and oriented generally in the first circumferential direction C1 toward the adjacent tip shroud 104. In certain embodiments, the spring may include a third segment 162 coupling the spring to one of the seal teeth 144, 146 and/or the tip shroud 104. For example, the spring may generally define an “F” profile. In further embodiments, the third segment 162 may also be oriented toward the adjacent tip shroud 104 to mechanically engage the tip shrouds 104. For example, the first compressible element 108 may mechanically engage the tip shroud 104 of an adjacent tip shroud 104 and/or may mechanically engage with a compressible element 108 of the adjacent tip shroud 104. As further illustrated in FIG. 4, one or more of the tip shrouds 104 may include a compressible element 108 oriented in each of the first circumferential directions C1 and a second circumferential direction C2 opposite the first circumferential direction C1. The compressible elements 108 may be mechanically engaged via friction and the compressive force between the compressible elements 108. In other embodiments, the compressible elements 108 may be coupled together.

It should be understood that the compressible element 108 of FIG. 4 is provided for example only. As such, the compressible element 108 may have any suitable configuration. For instance, the spring may define a “C” profile with a bottom portion 164 and a top portion 166. In certain configurations, the bottom portion 164 may be coupled to one of the tip shroud 104 or the flange 106. The top portion 166 may be oriented toward the adjacent tip shroud 104 to mechanically engage the tip shrouds 104. In certain embodiments, the top portion 166 may extend back toward the tip shroud 104 (e.g., generally in the second circumferential direction C2 for the exemplary compressible element 108) to couple to at least one of the shroud band 124 or the seal tooth 144, 146 to further secure the spring to the tip shroud 104. It should be recognized that, in further embodiments, the spring may have any configuration that allows the compressible elements 108 to mechanically engage each other or adjacent tip shrouds 104 and/or flanges 106. For instance, in certain embodiments, one or more of the compressible elements 108 may be configured as a prismatic spring or a leaf spring.

Referring still to the exemplary embodiment of FIG. 4, one or more of the tip shrouds 104 may define different lengths. For instance, as shown a first tip shroud 132 may define a first length 134 in a first direction. Further, a second tip shroud 136 may define a second length 138 in the first direction different than the first length 134. Moreover, as shown, the first direction may be defined at least partially in the circumferential direction C (such as entirely or approximately entirely in the circumferential direction C in the illustrated embodiment). Additionally, the second length 138 may be shorter than the first length 134. Moreover, the shorter second tip shroud 136 in combination with a rotor blade 119 (not shown) may have a higher natural frequency than the first tip shroud 132 in combination with a rotor blade 119. As such, the use of tip shrouds 104 having different natural frequencies may allow for detuning of the rotary component 80 and thereby reduce stress on the components of the rotary component 80 and the noise produced by the rotary component 80.

As further illustrated in FIG. 4, the shroud assembly 152 may further include one or more third tip shrouds 140 defining a third length 142 in the first direction (e.g., the circumferential direction C) different than the first and second lengths 134, 138. For instance, the third length 142 may be longer than the first length 134, which may be longer than the second length 138. Additionally, the longer third tip shroud 140 in combination with a rotor blade 119 (not shown) may have a lower natural frequency than the first tip shroud 132 in combination with a rotor blade 119, which as explained above may have a lower natural frequency than the shorter second tip shroud 136 in combination with a rotor blade 119. In one exemplary embodiment, the variation in natural frequencies between the first and second tip shrouds 132, 136 and the first and third tip shrouds 132, 140 may be between 5% and 15%, such as approximately 10%. As such, the use of three or more tip shrouds 104 with distinct lengths may further be utilized to detune the rotary component 80. However, it should be appreciated that the shroud assembly 152 may only include tip shrouds 104 defining two distinct lengths 134, 138. It should also be recognized that the shroud assembly 152 may include one or more tip shrouds 104 defining various additional lengths suitable for detuning the rotary component 80.

Furthermore, tip shrouds 104 defining different circumferential lengths may also define different rotational stiffnesses. More particularly, longer tip shroud 104 may define a larger stiffness as compared to a shorter tip shroud 104. For example, the first tip shroud(s) 132 defining the first length 134 may define a larger rotational stiffness than the second tip shroud(s) 136 defining the second length 138. Further, in embodiments that include the third tip shroud(s) 140, the third tip shroud 140 defining the third length 142 may define a larger rotational stiffness than the first tip shroud 132.

It should be recognized that the shroud assembly 152 of FIG. 4 is provided for illustrative purposes only. As such, the present disclosure may apply to any suitable shroud assembly including any suitable tip shrouds. For instance, the tip shrouds may define various shapes and include additional features or not include some or all of the features described herein. For example, the tip shrouds may be rectangular or trapezoidal in shape and may be interlocking in some embodiments.

Referring now to FIG. 5, a front view of a portion of an embodiment of the shroud assembly 152 is illustrated in accordance with aspects of the present subject matter. Particularly, FIG. 5 illustrates a shroud assembly 152 including tip shrouds 132, 134 defining two distinct lengths (first length 134 and second length 138). However, in other embodiments, the shroud assembly 152 may include further tip shrouds 104 defining one or more distinct additional lengths in the first direction (e.g., third tip shroud(s) 140).

As shown in FIG. 5, the shroud assembly 152 may include a first set 148 of tip shrouds 104 including two or more of the first tip shrouds 132. Furthermore, the rotary component 80 may include a first set 154 of rotor blades 119. Moreover, the each rotor blade 119 of the first set 154 of rotor blades 119 may be coupled to, integrally coupled to, or integrally formed with a first tip shroud 132 of the first set 148 of tip shrouds 132. Additionally, the shroud assembly 152 may include a second set 156 of tip shrouds 104 including two or more of the second tip shrouds 136. Furthermore, the rotary component 80 may include a second set 168 of rotor blades 119. Moreover, the each rotor blade 119 of the second set 168 of rotor blades 119 may be coupled to, integrally coupled to, or integrally formed with a second tip shroud 136 of the second set 156 of tip shrouds 132.

As further illustrated, each tip shroud 132 of the first set 148 of tip shrouds 132 and associated rotor blade 119 of the first set 154 of rotor blades 119 may alternative with each tip shroud 136 of the second set 156 of tip shrouds 136 and associated rotor blade 119 of the second set 168 of rotor blades 119. For instance, the first and second tip shrouds 132, 136 may alternate along at least a portion of (such as the entirety of) the perimeter of the shrouds assembly 152 and/or circumferential shroud 150 in the circumferential direction C. Additionally, adjacent rotor blades 119 may define circumferential gaps 170 in the circumferential direction C. Furthermore, the circumferential gaps 170 may be the same or approximately the same. As such, it should be appreciated the detuning of the rotary component 80 may not effect or substantially effect the aerodynamic performance of the rotary component 80. More particularly, the first and second sets 154, 168 of rotor blades 119 may be configured the same and the same or substantially the same circumferential gaps 170 may allow the rotary component 80 to operate as a detuned rotary component that does not substantially affect the performance thereof.

Furthermore, it should be appreciated that the difference in weight between the first tip shrouds 132 and the second tip shrouds 136 may be negligible or minimal when compared to the weight of the rotor blades 119. As such, the combined weight of each rotor blade 119 of the first set 154 of rotor blades 119 coupled to one of the first tip shrouds 132 may weigh approximately the same as the combined weight of each rotor blade 119 of the second set 168 of rotor blades 119 coupled to one of the second tip shrouds 136. Moreover, it should be appreciated that if the weight difference between the first and second tip shrouds 132, 136 is negligible or minimal compared to the combined weight of the tip shrouds 132, 136 and their respective rotor blades 119, the overall rotary component 80 may be detuned without adversity affecting the weight of the rotary component 80 and therefore the efficiency of the gas turbine engine 10. Moreover, it should be appreciated that embodiments including tip shrouds 104 with additional lengths (e.g., the third tip shroud 140), the weight difference between the third tip shrouds 140 and the first tip shrouds 132 and/or second tip shrouds 136 may be negligible when compared to the combined weight of the tip shrouds 132, 136, 140 and their respective rotor blades 119.

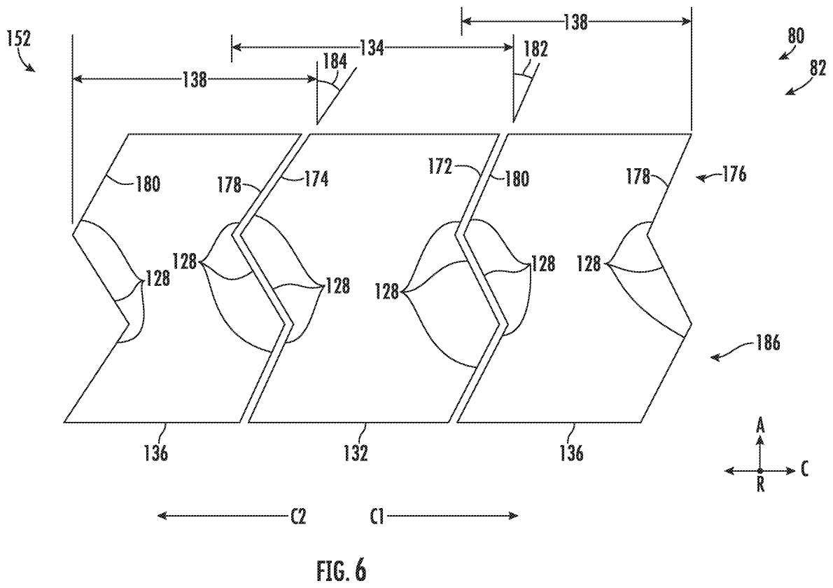

Referring now to FIG. 6, a schematic top view is illustrated of an additional or alternative embodiment of a portion of the shroud assembly 152 in accordance with aspects of the present subject matter. Particularly, FIG. 6 illustrates a shroud assembly 152 defining different contact angles for the tip shrouds 104 with the flanges 106, compressible elements 108, and seal teeth 144, 146 omitted for clarity. By adjusting the contact angles of the tip shrouds 104, the interface and/or orientation between tip shrouds 132, 136 defining different lengths 134, 134 may be altered and thus improve the interconnectivity of the shroud assembly 152.

As shown, the tip shroud 104 may define contact faces 128 disposed circumferentially between adjacent tip shrouds 104 in order to define the interfaces between the tip shrouds 104 of the shroud assembly 152. As shown, the first tip shroud(s) 132 may include a first contact surface 172 and a second contact surface 174 at a downstream section 176 of the stage 82 of the rotary component 80. Moreover, the first contact surface 172 may be oriented in the first circumferential direction C1, and the second contact surface 174 may be oriented in the second circumferential direction C2. Furthermore, the second tip shroud(s) 136 may include a third contact surface 178 and a fourth contact surface 180 at the downstream section 176 of the stage 82 of the rotary component 80. Moreover, the third contact surface 178 may be oriented in the first circumferential direction C1, and the fourth contact surface 180 may be disposed in the second circumferential direction C2. As illustrated, the first contact surface 172 may define a first contact angle 182 relative to the axial direction A. Additionally, the third contact surface 178 may define a second contact angle 184 relative to the axial direction A. As such, the first contact angle 182 may be smaller than the second contact angle 184. It should be appreciated that the fourth contact surface 180 may define the same first contact angle 182 as first contact surface 172, and third contact surface 178 may define the same second contact angle 184 as second contact surface 174. It should be appreciated that tip shrouds 104 defining the same angle on adjacent contact surfaces 128 may provide a desirable interface between tip shrouds 104 and/or allow the tip shrouds 104 to interlock.

Though described in relation to the downstream section 176 of the stage 82, an upstream section 186 of the stage 82 may define different contact angles. In certain embodiments, the contact angles orientation between the downstream section 176 and the upstream section 186 may be oppositely oriented to each other relative to the circumferential direction C. For example, as shown, the contact faces 128 oriented in the second circumferential direction C2 of the first tip shroud 132 may define a smaller contact angle relative to the axial direction A compared to a contact angle defined by the contact faces 128 of the second tip shroud 136 oriented in the second circumferential direction C2. Furthermore, the smaller contact angle may be the same or approximately the same as the first contact angle 182, and the larger contact angle may be the same or approximately the same as the second contact angle 184.

Further aspects of the invention are provided by the subject matter of the following clauses:

1. A shroud assembly for a rotary component of a gas turbine engine defining a central axis extending along an axial direction, a radial direction extending perpendicular to the axial direction, and a circumferential direction perpendicular to both the central axis and the radial direction, the shroud assembly comprising a plurality of tip shrouds, each tip shroud of the plurality of tip shrouds including a shroud band, wherein each tip shroud of the plurality of tip shrouds is configured to be coupled to one of a plurality of rotor blades at a tip end, the plurality of tip shrouds comprising a first tip shroud defining a first length in a first direction and a second tip shroud defining a second length in the first direction, the second length being different than the first length.

2. The shroud assembly of clause 1, wherein the first direction is defined in the circumferential direction.

3. The shroud assembly of any preceding clause, wherein the second length is shorter than the first length.

4. The shroud assembly of any preceding clause, wherein the first tip shroud includes a first contact face in a first circumferential direction, the first contact face defining a first contact angle relative to the axial direction, and wherein the second tip shroud defines a second contact face in the first circumferential direction, the second contact face defining a second contact angle relative to the axial direction, the second contact angle different than the first contact angle.

5. The shroud assembly of any preceding clause, wherein the second contact angle is greater than the first contact angle.

6. The shroud assembly of any preceding clause, wherein the plurality of tip shrouds further comprises a third tip shroud defining a third length in the first direction, the third length being different than both the first length and the second length.

7. The shroud assembly of any preceding clause, wherein the second length is shorter than the first length and the third length is longer than the first length.

8. The shroud assembly of any preceding clause, wherein the plurality of tip shrouds further comprises a first set of tip shrouds, each tip shroud of the first set of tip shrouds configured as the first tip shroud; and a second set of tip shrouds, each tip shroud of the second set of tip shrouds configured as the second tip shroud.

9. The shroud assembly of any preceding clause, wherein each tip shroud of the first set of tip shrouds alternates with each of the tip shrouds of the second set of tip shrouds in the circumferential direction.

10. A rotary component for a gas turbine engine defining a central axis extending along an axial direction, a radial direction extending perpendicular to the axial direction, and a circumferential direction perpendicular to both the central axis and the radial direction, the rotary component comprising a plurality of rotor blades, each rotor blade of the plurality of rotor blades having a body extending radially from a root end coupled to a rotating shaft of the gas turbine engine to a tip end, the plurality of rotor blades arranged circumferentially in a stage and a plurality of tip shrouds, each tip shroud of the plurality of tip shrouds including a shroud band, wherein each tip shroud of the plurality of tip shrouds is coupled to a rotor blade of the plurality of rotor blades at the tip end, the plurality of tip shrouds comprising a first tip shroud defining a first length in a first direction and a second tip shroud defining a second length in the first direction, the second length being different than the first length.

11. The rotary component of any preceding clause, wherein the first direction is defined in the circumferential direction.

12. The rotary component of any preceding clause, wherein the second length is shorter than the first length.

13. The rotary component of any preceding clause, wherein the first tip shroud includes a first contact face in a first circumferential direction, the first contact face defining a first contact angle relative to the axial direction, and wherein the second tip shroud defines a second contact face in the first circumferential direction, the second contact face defining a second contact angle relative to the axial direction, the second contact angle different than the first contact angle.

14. The rotary component of any preceding clause, wherein the second contact angle is greater than the first contact angle.

15. The rotary component of any preceding clause, wherein the plurality of tip shrouds further comprises a third tip shroud defining a third length in the first direction, wherein the second length is shorter than the first length and the third length is longer than the first length.

16. The rotary component of any preceding clause, wherein the plurality of tip shrouds further comprises a first set of tip shrouds, each tip shroud of the first set of tip shrouds configured as the first tip shroud, and a second set of tip shrouds, each tip shroud of the second set of tip shrouds configured as the second tip shroud.

17. The rotary component of any preceding clause, wherein each tip shroud of the first set of tip shrouds alternates with each of the tip shrouds of the second set of tip shrouds in the circumferential direction.

18. The rotary component of any preceding clause, wherein the plurality of rotor blades further comprises a first set of rotor blades, each rotor blade of the first set of rotor blades coupled to one of the first set of tip shrouds, and a second set of rotor blades, each rotor blade of the second set of rotor blades coupled to one of the second set of tip shrouds, wherein a combined weight of each rotor blade of the first set of rotor blades coupled to one of the first tip shrouds weighs approximately the same as a combined weight of each rotor blade of the second set of rotor blades coupled to one of the second tip shrouds.

19. The rotary component of any preceding clause, wherein the rotary component defines a circumferential gap between each of the plurality of rotor blades in the circumferential direction, and wherein each circumferential gap is the same or approximately the same.

20. The rotary component of any preceding clause, wherein the rotary component is configured as a turbine of the gas turbine engine, and wherein each of the rotor blades is configured as a turbine blade.

21. A band assembly for a rotary component of a gas turbine engine defining a central axis extending along an axial direction, a radial direction extending perpendicular to the axial direction, and a circumferential direction perpendicular to both the central axis and the radial direction, the band assembly comprising a plurality of bands, the plurality of bands configured as outer bands or inner bands, wherein each band of the plurality of bands is configured to be coupled to one of a plurality of stator vanes at a tip end or a root end, the plurality of bands comprising a first band defining a first length in a first direction and a second band defining a second length in the first direction, the second length being different than the first length.

22. The band assembly of any preceding clause, wherein each band of the plurality of bands is configured as an outer band, each outer band configured to be coupled to one of the plurality of stator vanes at the tip end.

23. The band assembly of any preceding clause, wherein each band of the plurality of bands is configured as an inner band, each inner band configured to be coupled to one of the plurality of stator vanes at the root end.

24. The band assembly of any preceding clause, wherein the first direction is defined in the circumferential direction.

25. The band assembly of any preceding clause, wherein the second length is shorter than the first length.

26. The band assembly of any preceding clause, wherein the first band includes a first contact face in a first circumferential direction, the first contact face defining a first contact angle relative to the axial direction, and wherein the second band defines a second contact face in the first circumferential direction, the second contact face defining a second contact angle relative to the axial direction, the second contact angle different than the first contact angle.

27. The band assembly of any preceding clause, wherein the second contact angle is greater than the first contact angle.

28. The band assembly of any preceding clause, wherein the plurality of bands further comprises a third band defining a third length in the first direction, the third length being different than both the first length and the second length.

29. The band assembly of any preceding clause, wherein the second length is shorter than the first length and the third length is longer than the first length.

30. The band assembly of any preceding clause, wherein the plurality of bands further comprises a first set of tip bands, each band of the first set of bands configured as the first band; and a second set of bands, each band of the second set of bands configured as the second band.

31. The band assembly of any preceding clause, wherein each band of the first set of bands alternates with each of the bands of the second set of bands in the circumferential direction.

32. A rotary component for a gas turbine engine defining a central axis extending along an axial direction, a radial direction extending perpendicular to the axial direction, and a circumferential direction perpendicular to both the central axis and the radial direction, the rotary component comprising a plurality of stator vanes, each stator vane of the plurality of stator vanes having a body extending radially from a root end coupled to a frame of the gas turbine engine to a tip end coupled to an outer casing of the gas turbine engine, the plurality of stator vanes arranged circumferentially in a stage and a plurality of bands, the plurality of bands configured as outer bands or inner bands, wherein each band of the plurality of bands is coupled to one of a plurality of stator vanes at the tip end or the root end, the plurality of bands comprising a first band defining a first length in a first direction and a second band defining a second length in the first direction, the second length being different than the first length.

33. The rotary component of any preceding clause, wherein each band of the plurality of bands is configured as an outer band, each outer band coupled to one of the plurality of stator vanes at the tip end.

34. The rotary component of any preceding clause, wherein each band of the plurality of bands is configured as an inner band, each inner band coupled to one of the plurality of stator vanes at the root end.

35. The rotary component of any preceding clause, wherein the first direction is defined in the circumferential direction.

36. The rotary component of any preceding clause, wherein the second length is shorter than the first length.

37. The rotary component of any preceding clause, wherein the first band includes a first contact face in a first circumferential direction, the first contact face defining a first contact angle relative to the axial direction, and wherein the band defines a second contact face in the first circumferential direction, the second contact face defining a second contact angle relative to the axial direction, the second contact angle different than the first contact angle.

38. The rotary component of any preceding clause, wherein the second contact angle is greater than the first contact angle.

39. The rotary component of any preceding clause, wherein the plurality of bands further comprises a third tip band defining a third length in the first direction, wherein the second length is shorter than the first length and the third length is longer than the first length.

40. The rotary component of any preceding clause, wherein the plurality of bands further comprises a first set of bands, each band of the first set of bands configured as the first band, and a second set of bands, each band of the second set of bands configured as the second band.

42. The rotary component of any preceding clause, wherein each band of the first set of bands alternates with each of the bands of the second set of bands in the circumferential direction.

44. The rotary component of any preceding clause, wherein the plurality of stator vanes further comprises a first set of stator vanes, each stator vane of the first set of stator vanes coupled to one of the first set of bands, and a second set of stator vanes, each stator vane of the second set of stator vanes coupled to one of the second set of bands, wherein a combined weight of each stator vane of the first set of vanes coupled to one of the first bands weighs approximately the same as a combined weight of each stator vane of the second set of stator vanes coupled to one of the second bands.

45. The rotary component of any preceding clause, wherein the rotary component defines a circumferential gap between each of the plurality of stator vanes in the circumferential direction, and wherein each circumferential gap is the same or approximately the same.

46. The rotary component of any preceding clause, wherein the rotary component is configured as a turbine of the gas turbine engine, and wherein each of the stator vanes is configured as a turbine stator vane.

47. A band assembly for a rotary component of a gas turbine engine defining a central axis extending along an axial direction, a radial direction extending perpendicular to the axial direction, and a circumferential direction perpendicular to both the central axis and the radial direction, the band assembly comprising a plurality of bands, the plurality of bands configured as outer bands or inner bands, wherein each band of the plurality of bands is configured to be coupled to one of a plurality of airfoils at a tip end or a root end, the plurality of bands comprising a first band defining a first length in a first direction and a second band defining a second length in the first direction, the second length being different than the first length.

48. The band assembly of any preceding clause, wherein each airfoil of the plurality of airfoils is configured as a stator vane.

49. The band assembly of any preceding clause, wherein each airfoil of the plurality of airfoils is configured as a rotor blade.

50. The band assembly of any preceding clause, wherein each band of the plurality of bands is configured as an outer band, each outer band configured to be coupled to one of the plurality of airfoils at the tip end.

51. The band assembly of any preceding clause, wherein each band of the plurality of bands is configured as an inner band, each inner band configured to be coupled to one of the plurality of airfoils at the root end.

52. The band assembly of any preceding clause, wherein the first direction is defined in the circumferential direction.

53. The band assembly of any preceding clause, wherein the second length is shorter than the first length.

54. The band assembly of any preceding clause, wherein the first band includes a first contact face in a first circumferential direction, the first contact face defining a first contact angle relative to the axial direction, and wherein the second band defines a second contact face in the first circumferential direction, the second contact face defining a second contact angle relative to the axial direction, the second contact angle different than the first contact angle.

55. The band assembly of any preceding clause, wherein the second contact angle is greater than the first contact angle.

56. The band assembly of any preceding clause, wherein the plurality of bands further comprises a third band defining a third length in the first direction, the third length being different than both the first length and the second length.

57. The band assembly of any preceding clause, wherein the second length is shorter than the first length and the third length is longer than the first length.

58. The band assembly of any preceding clause, wherein the plurality of bands further comprises a first set of tip bands, each band of the first set of bands configured as the first band; and a second set of bands, each band of the second set of bands configured as the second band.

60. The band assembly of any preceding clause, wherein each band of the first set of bands alternates with each of the bands of the second set of bands in the circumferential direction.

This written description uses exemplary embodiments to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A shroud assembly for a rotary component of a gas turbine engine defining a central axis extending along an axial direction, a radial direction extending perpendicular to the axial direction, and a circumferential direction perpendicular to both the central axis and the radial direction, the shroud assembly comprising:
a plurality of tip shrouds, each tip shroud of the plurality of tip shrouds including a shroud band, wherein each tip shroud of the plurality of tip shrouds is configured to be coupled to one of a plurality of rotor blades at a tip end, the plurality of tip shrouds comprising:
a first tip shroud defining a first length in a first direction; and
a second tip shroud defining a second length in the first direction, the second length being different than the first length.

2. The shroud assembly of claim 1, wherein the first direction is defined in the circumferential direction.

3. The shroud assembly of claim 1, wherein the second length is shorter than the first length.

4. The shroud assembly of claim 1, wherein the first tip shroud includes a first contact face in a first circumferential direction, the first contact face defining a first contact angle relative to the axial direction, and wherein the second tip shroud defines a second contact face in the first circumferential direction, the second contact face defining a second contact angle relative to the axial direction, the second contact angle different than the first contact angle.

5. The shroud assembly of claim 4, wherein the second contact angle is greater than the first contact angle.

6. The shroud assembly of claim 1, wherein the plurality of tip shrouds further comprises:
a third tip shroud defining a third length in the first direction, the third length being different than both the first length and the second length.

7. The shroud assembly of claim 6, wherein the second length is shorter than the first length and the third length is longer than the first length.

8. The shroud assembly of claim 1, wherein the plurality of tip shrouds further comprises:
a first set of tip shrouds, each tip shroud of the first set of tip shrouds configured as the first tip shroud; and
a second set of tip shrouds, each tip shroud of the second set of tip shrouds configured as the second tip shroud.

9. The shroud assembly of 8, wherein each tip shroud of the first set of tip shrouds alternates with each of the tip shrouds of the second set of tip shrouds in the circumferential direction.

10. A rotary component for a gas turbine engine defining a central axis extending along an axial direction, a radial direction extending perpendicular to the axial direction, and a circumferential direction perpendicular to both the central axis and the radial direction, the rotary component comprising:
a plurality of rotor blades, each rotor blade of the plurality of rotor blades having a body extending radially from a root end coupled to a rotating shaft of the gas turbine engine to a tip end, the plurality of rotor blades arranged circumferentially in a stage; and
a plurality of tip shrouds, each tip shroud of the plurality of tip shrouds including a shroud band, wherein each tip shroud of the plurality of tip shrouds is coupled to a rotor blade of the plurality of rotor blades at the tip end, the plurality of tip shrouds comprising:
a first tip shroud defining a first length in a first direction; and
a second tip shroud defining a second length in the first direction, the second length being different than the first length.

11. The rotary component of claim 10, wherein the first tip shroud includes a first contact face in a first circumferential direction, the first contact face defining a first contact angle relative to the axial direction, and wherein the second tip shroud defines a second contact face in the first circumferential direction, the second contact face defining a second contact angle relative to the axial direction, the second contact angle different than the first contact angle.

12. The rotary component of claim 11, wherein the second contact angle is greater than the first contact angle.

13. The rotary component of claim 10, wherein the plurality of tip shrouds further comprises:
a first set of tip shrouds, each tip shroud of the first set of tip shrouds configured as the first tip shroud; and
a second set of tip shrouds, each tip shroud of the second set of tip shrouds configured as the second tip shroud.

14. The rotary component of claim 13, wherein each tip shroud of the first set of tip shrouds alternates with each of the tip shrouds of the second set of tip shrouds in the circumferential direction.

15. The rotary component of claim 14, wherein the plurality of rotor blades further comprises:
a first set of rotor blades, each rotor blade of the first set of rotor blades coupled to one of the first set of tip shrouds; and
a second set of rotor blades, each rotor blade of the second set of rotor blades coupled to one of the second set of tip shrouds,
wherein a combined weight of each rotor blade of the first set of rotor blades coupled to one of the first tip shrouds weighs approximately the same as a combined weight of each rotor blade of the second set of rotor blades coupled to one of the second tip shrouds.

16. The rotary component of claim 10, wherein the rotary component defines a circumferential gap between each of the plurality of rotor blades in the circumferential direction, and wherein each circumferential gap is the same or approximately the same.

17. The rotary component of claim 10, wherein the rotary component is configured as a turbine of the gas turbine engine, and wherein each of the rotor blades is configured as a turbine blade.

18. A band assembly for a rotary component of a gas turbine engine defining a central axis extending along an axial direction, a radial direction extending perpendicular to the axial direction, and a circumferential direction perpendicular to both the central axis and the radial direction, the band assembly comprising:
a plurality of bands, the plurality of bands configured as outer bands or inner bands, wherein each band of the plurality of bands is configured to be coupled to one of a plurality of airfoils at a tip end or a root end, the plurality of bands comprising:
a first band defining a first length in a first direction; and
a second band defining a second length in the first direction, the second length being different than the first length.

19. The band assembly of claim 18, wherein each airfoil of the plurality of airfoils is configured as a stator vane.

20. The band assembly of claim 18, wherein each band of the plurality of bands is configured as an outer band, each outer band configured to be coupled to one of the plurality of airfoils at the tip end.
